(19) United States
(12) Patent Application Publication
(10) Pub. No.: US 2005/0011771 A1
(43) Pub. Date: Jan. 20, 2005

(54) Chlorite sensor

(76) Inventors: Michael Wittkampf, Heidelberg (DE); Alexander Pinkowski, Palencia (ES)

Correspondence Address: SIMPSON & SIMPSON, PLLC, 5555 MAIN STREET, WILLIAMSVILLE, NY, 14221-5406, US

(21) Appl. No.: 10/851,446

(22) Filed: May 21, 2004

(30) Foreign Application Priority Data
May 21, 2003 (DE) 10322894.2

(51) Int. Cl. G01N 27/26

(52) U.S. Cl. 205/778.5; 204/415

(57) ABSTRACT

The present invention concerns a sensor for voltammetric or amperometric measurement of the chlorite concentration (ClO₂⁻) in an solution. In order to provide a chlorite sensor which permits direct measurement of the chlorite concentration without taking samples, separating off accompanying substances or adding chemicals, and which has negligible cross-sensitivity in relation to typical accompanying substances of the chlorite, such as in particular chlorine dioxide (ClO₂), chlorate (ClO₃⁻) and hypochlorite (OCl⁻), it is proposed in accordance with the invention that the sensor has a working electrode of gold.

### SUBJECT OF THE INVENTION

The invention concerns a sensor for voltammetric or amperometric measurement of the chlorite concentration (ClO₂⁻) in an aqueous measurement solution. More specifically the invention concerns an open or membrane-covered chlorite sensor which specifically can quantitatively detect the toxic chlorite ions (ClO₂⁻) in for example drinking water disinfected with chlorine dioxide (ClO₂) without cross-sensitivity for the usual accompanying substances, such as chlorine dioxide (ClO₂), hypochlorite (OCl⁻) and chlorate (ClO₃⁻) and with a high level of sensitivity has negligible dependency on the pH-value of the measurement solution in the pH-range of from 6.0 to 9.5.

### STATE OF THE ART

In the known chloritic acid process for chlorine dioxide production, chlorine dioxide (ClO₂) is formed in accordance with the following diagram by reaction of sodium chlorite (NaClO₂) with acid, mostly hydrochloric acid:
5 ClO₂⁻+4 H¹→4 ClO₂+Cl⁻+2 H₂O

In the reverse reaction chlorine dioxide (ClO₂) is used in various processes such as for example in the disinfecting of drinking water. That produces inter alia chlorite (ClO₂⁻) which like chlorine dioxide also has a bactericidal action. As however chlorite is toxic, various national directives only allow low levels of residual concentration of chlorite in drinking water, such as for example 0.2 to 1 ppm of chlorite. Therefore, in order to observe those limit values, it is necessary to continuously measure the chlorite content of drinking water in drinking water purification with chlorine dioxide.

A further direct application of chlorite is its use as an anti-microbial process water additive in the processing of poultry, meat or seafoods. After treatment with the process water those foodstuffs are rinsed with drinking water inter alia to remove the chlorite, in order to comply with the prescribed chlorite limit values. In this case also continuous measurement of the chlorite content in the process water and/or rinsing water is required.

At the present time there are no continuously operating and reliably measuring sensors available for determining chlorite in an aqueous measurement solution. Measuring processes used at the present time are complicated and/or costly and operate discontinuously, that is to say they are linked to a sampling procedure such as iodometric titration or photometric detection with DPD reagent which, as experience has shown, in the presence of chlorine dioxide furnishes excessively low chlorite values. To avoid chlorite determination being disrupted by accompanying substances, some processes require a separation operation which is implemented prior to the actual measurement or determining procedure, such as ion chromatography or capillary electrophoresis.

A further application of chlorite is flue gas scrubbing in which nitrogen oxides are removed from flue gases by means of sodium chlorite-bearing solutions. To determine the chlorite content, German utility model DE 85 27 071.7 and U.S. Pat. No. 4,767,601 propose a heat toning measurement procedure in which the increase in temperature upon a reaction of the chlorite with an adjuvant, such as for example sulphur dioxide gas, is measured. That process however is non-specific and susceptible to being disturbed by accompanying substances. By virtue of the necessary addition of a reacting adjuvant, the process moreover can also not be used directly in the drinking water flow but requires a part of the flow to be branched off as measurement liquid, and that then has to be thrown away after the measurement operation.

DE-OS No 41 09 909 describes an electrode system for voltammetric measurement using a working electrode of glass carbon and a counterpart electrode of a metal (platinum, gold, silver, titanium, Hastelloy C), with which it is said to be possible inter alia, besides the chlorine dioxide concentration, also to determine the high levels of chlorite concentration produced in typical bleaching solutions in the paper and pulp industry, at pH-values in the range of 2 to 7. In an embodiment by way of example in which the voltage was measured as a function of the pH-value at a constant chlorite concentration over the pH-value range of 2 to 7, it was shown that the change in voltage in the specified pH-value range was at least 50 mV, which would signify at least almost an order of magnitude of the change in concentration, for the desired measurements of the oxidation and/or reduction potentials.

### OBJECT OF THE INVENTION

The object of the present invention is to provide a chlorite sensor which permits direct measurement of the chlorite concentration without taking a sample, separation of accompanying substances or addition of chemicals, which has negligible cross-sensitivity in relation to typical accompanying substances of the chlorite such as in particular chlorine dioxide (ClO₂), chlorate (ClO₃⁻) and hypochlorite (OCl⁻), which is suitable for the detection of small amounts of chlorite in the region of up to 5 ppm and which with a high degree of probe steepness, has negligible dependency on the pH-value in the pH-value range of 6.0 to 9.5.

### ATTAINMENT OF THE OBJECT

The object according to the invention is attained by a sensor of the kind set forth in the opening part of this specification, wherein the sensor has a working electrode of gold.

It was surprisingly found that the use of a working electrode of gold in a sensor for amperometric or voltammetric measurement of chlorite in aqueous measurement solutions allows high polarisation voltages without passivation and without oxygen generation at the working electrode. In that respect the term passivation is used to denote the formation of surface oxides at the working electrode. With the sensor according to the invention, it is possible to use a very high anodic potential which is only about 300 mV below the potential of incipient anodic passivation. Surprisingly it was found that, with such an amperometrically or voltammetrically operated electrode arrangement with a gold working electrode, when applying such high potentials, it is not only possible to reduce the cross-sensitivity of the measured signal for typical and partly inevitable accompanying substances of the chlorite such as chlorine dioxide (ClO₂), chlorate (ClO₃⁻) and hypochlorite (HOCl), to such an extent that it is negligible. It was also surprisingly found that the sensor according to the invention makes it possible to achieve an extremely low level of pH-value dependency in the pH-value range of 6.0 to 9.5.

A possible explanation for the fact that the use of gold as the working electrode, in contrast to other precious metal electrodes such as platinum electrodes, or glass carbon electrodes, affords the above-indicated low cross-sensitivity and low level of pH-value dependency, could be that gold, at the required high anodic potential, is not yet passivated and no oxygen generation yet occurs thereat. The term high potential is used to denote a potential of about 900 to 1150 mV in relation to the normal hydrogen electrode (NHE) which by convention is 0 mV.

In principle it would be assumed that a platinum working electrode should also be suitable for the purpose according to the invention. It has been found however that the sensitivity (steepness) of a sensor with a platinum electrode is less than that of a sensor with a gold working electrode as the platinum surface is already passivated at the required high anodic potentials. Because oxygen generation which is harmful to the sensor function occurs at oxide-covered, passivated electrodes or on the other hand typical electrode reactions arc suppressed at oxide-covered electrodes, the gold working electrode has considerable advantages over the platinum electrode.

A glass carbon working electrode is still less suitable for the purpose according to the invention than a platinum working electrode as a glass carbon working electrode has marked pH-value dependency in respect of the zero point and thus the measured signal in the presence of chlorite.

The chlorite sensor according to the invention is specific for chlorite ions and has scarcely any cross-sensitivity in relation to the above-mentioned typical substances accompanying chlorite. As the sensor does not discharge any substances into the measurement water, it is particularly suitable for determining the chlorite content directly in drinking water without the need to withdraw a sample which later has to he discarded. The chlorite sensor according to the invention can be used continuously so that the chlorite content can be automatically measured permanently or at short intervals and by means of a suitably designed electronic detection system.

The chlorite sensor according to the invention can be operated voltammetrically, amperometrically or also cyclovoltammetrically. It can be provided in any usual configuration of known measuring electrode systems, preferably in the form of a two-electrode system or a three-electrode system. In a three-electrode system the sensor advantageously includes a working electrode of gold, a conventional reference electrode, for example a silver/silver chloride electrode and a conventional counterpart electrode, for example a platinum electrode. The working electrode of gold can be in the form of an open or membrane-covered working electrode. When the working electrode of the sensor according to the invention is of an ‘open’ configuration, the working electrode is adapted to be freely accessible for direct contact with the measurement solution.

For measuring the chlorite concentration with the chlorite sensor according to the invention in an aqueous measurement solution, a constant anodic potential of +900 to +1150 mV in relation to the normal hydrogen electrode is desirably applied between the working electrode and the counterpart electrode, as the working voltage, and the current flowing at the working voltage is measured. Preferably the working voltage is in the range of +1000 to +1100 mV, particularly preferably being about 1000 mV in relation to the normal hydrogen electrode. The resulting measurement current is evaluated as an amperometric signal proportional to the chlorite concentration.

In a preferred embodiment of the sensor according to the invention the working electrode of gold is spatially separated from the measurement solution by a membrane, wherein the membrane is preferably a hydrophilic or hydrophilised membrane. Particularly preferably the membrane comprises polyvinylidene difluoride (PVDF) or polyethyleneterephthalate (PET). It is further desirable if the membrane has a pore size of 0.1 to 5 μm, preferably a pore size of 0.2 to 1.0 μm, particularly preferably a pore size of about 0.5.

In a particularly preferred embodiment of the membrane-covered chlorite sensor according to the invention the electrodes are surrounded by a membrane cap which separates the electrodes from the measurement solution, wherein the membrane cap is filled with an internal electrolyte which is in contact with the electrodes and the membrane cap has at least one membrane which separates the internal space of the membrane cap and the external space of the measurement solution. The liquid-tight material of the membrane cap has at least one opening which is spanned by the porous membrane. The internal electrolyte is in contact with the working electrode and the membrane. An example of a suitable membrane material is the above-mentioned polyvinylidene difluoride (PVDF) with a pore size of about 0.5 μm. Other semi-permeable membranes or also diaphragms are also suitable according to the invention.

In the embodiment of the sensor according to the invention with membrane-covered working electrode, preferably a potassium chloride solution (KCl) is used as the internal electrolyte. It can advantageously be thickened with a conventional gelling agent such as for example with hydroxyethylcellulose.

The working electrode on the chlorite sensor according to the invention is preferably gold in the form of a pin of substantially circular cross-section and of a diameter of about 1 mm to about 5 mm, preferably about 1.5 mm to 3 mm, particularly preferably about 2 mm. Alternatively, it is also possible to use as the electrode a base body which serves as a carrier and which is plated with gold, electrical discharge being effected directly by the gold plating.

Besides the above-mentioned advantages, the working electrode of gold in the chlorite sensor according to the invention has the property that it is chemically and electrochemically relatively inert and in comparison with other precious metal electrodes allows higher polarisation voltages in aqueous solutions without electrolytic decomposition of water. The high potentials which in the case of the gold electrode used in accordance with the invention are particularly advantageous in regard to cross-sensitivity for accompanying materials already result in initiation of electrolytic decomposition of water when other known precious metal electrodes are used, so that a measurement operation with other precious metal electrodes is not possible when such high anodic potentials are involved.

The current which flows when the working voltage is applied is evaluated as a chlorite concentration-proportional signal by means of a suitable electronic detection system which has long been known in the field of sensor systems and which is not subject-matter of the present invention. The chlorite sensor according to the invention can also be operated for example cyclovoltammetrically or in the potential change procedure, in which case an anodic potential in the range of −1000 to +1300 mV in relation to NHF is advantageously involved.

With the above-indicated working voltage of amperometric measurement in the range of +900 to +1150 mV in relation to NHE the sensor according to the invention operates in the diffusion limit current range. In that situation the following oxidation reaction takes place at the working electrode:
ClO₂⁻→ClO₂+e⁻.

In that respect the diffusion limit current range means that, with the applied potential, all of the analyte which diffuses to the electrode surface is reacted. The resulting oxidation current can thus be evaluated as a signal proportional to the chlorite concentration.

Besides direct amperometric application with a potential which is constant in respect of time, the chlorite sensor according to the invention can also be used with the process of cyclovoltammetry. In that case a potential range in the form of a triangle (travel to and fro) is implemented at a predetermined potential advance rate [mV/s] and the current flowing in that situation is measured. The level of the current at a potential in the diffusion-controlled region of the cyclovoltammogram is in that case once again proportional to the concentration of the analyte.

A further variant is the potential change process. In that case a potential or a plurality of potentials above or also below the actual measurement potential is or are applied. In that case it is advantageously possible to effect for example simultaneous regeneration by the removal of reaction products or adsorbed substances from the electrode surface, by a procedure whereby the various potentials are applied in a given sequence for a predetermined time and it is only at the actual measurement potential that current measurement is effected for quantifying the chlorite content.

The description hereinafter and the accompanying Figures describe a particularly preferred embodiment of the chlorite sensor according to the invention and measurement results by way of example with the sensor according to the invention and comparative examples.

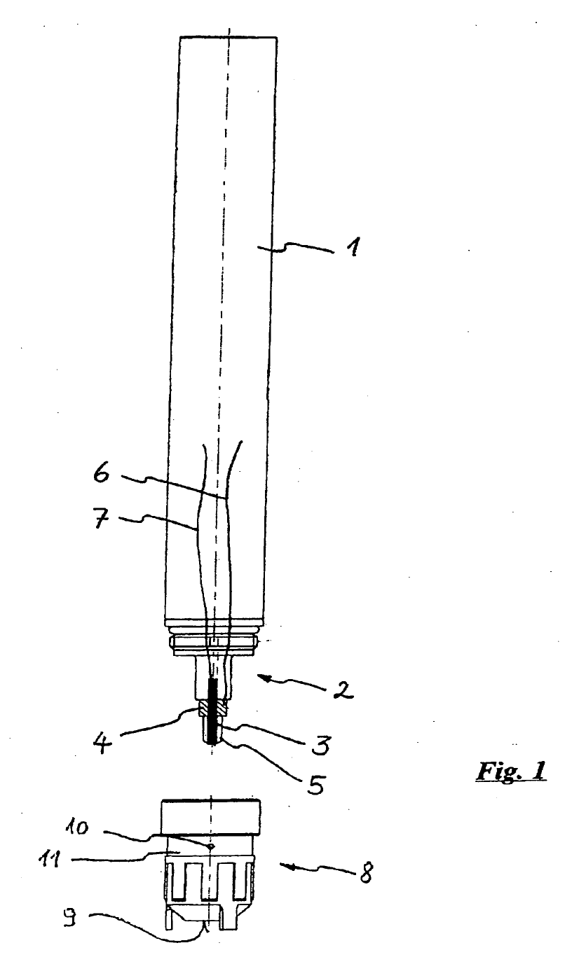

FIG. 1 is a diagrammatic view of a chlorite sensor according to the invention in the form of a two-electrode system with a membrane-covered working electrode of gold,

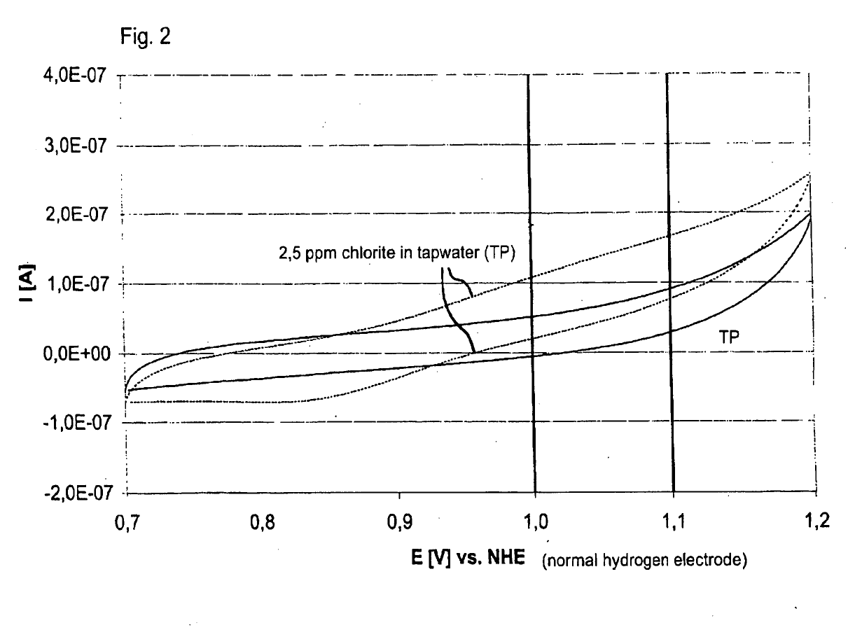

FIG. 2 shows cyclovoltammograms in tap water (TW) without chlorite and with 2.5 mm of chlorite respectively, in each case at a pH-value of 7.2, using the chlorite sensor according to the invention as shown in FIG. 1,

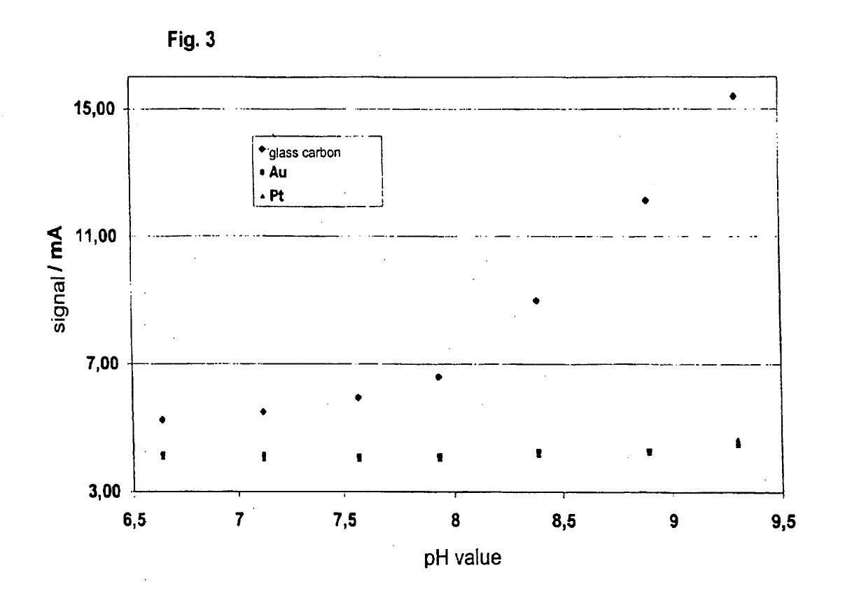

FIG. 3 shows the dependency of the zero point signal on the pH-value of sensors with three different working electrode materials (gold, platinum and glass carbon) which were measured with the same test arrangement,

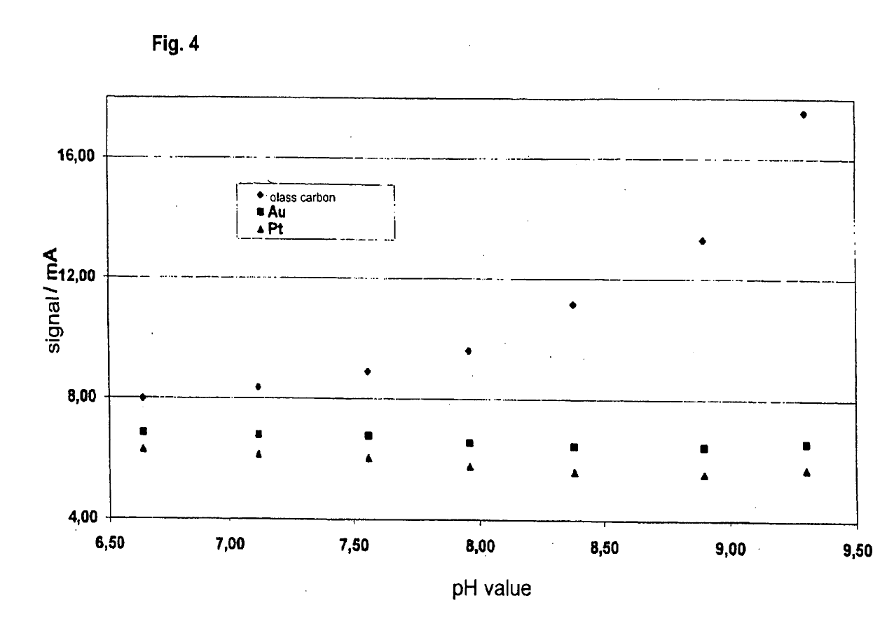

FIG. 4 shows the dependency of the chlorite signal on the pH-value of sensors with three different working electrode materials (gold, platinum and glass carbon) which were measured with the same test arrangement and at 0.5 ppm of chlorite, and

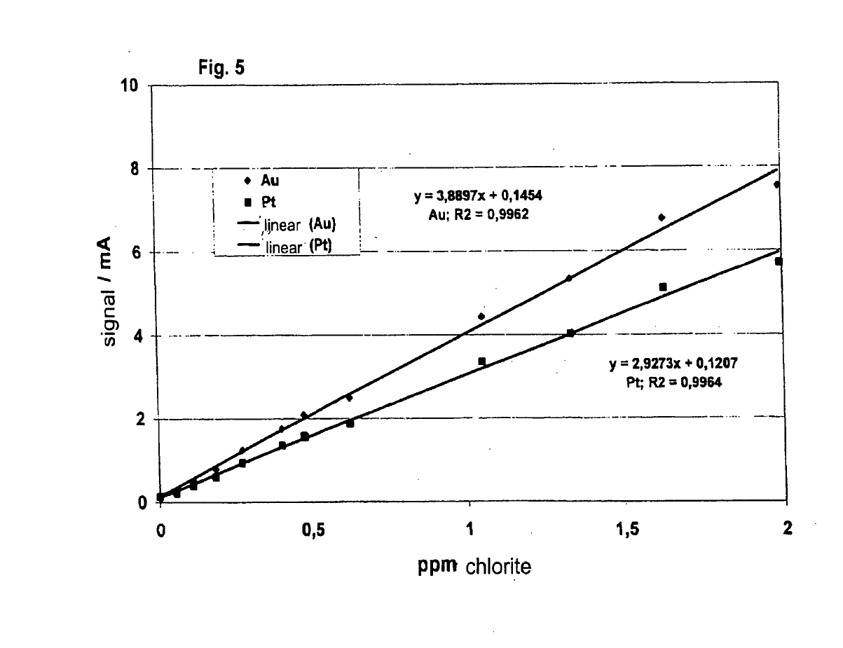

FIG. 5 shows characteristic curves of chlorite sensors with working electrodes of gold or platinum respectively at a constant pH-value and over a chlorite range of 0 to 2 ppm.

FIG. 1 shows a particularly preferred embodiment of a chlorite sensor according to the invention in the form of a two-electrode system. The sensor has an electrode shaft 1 which is of a substantially cylindrical configuration and an electrode body 2 which is fixed to an end of the electrode shaft 1, preferably being screwed therein. The electrode body has a substantially bar-shaped working electrode 3 of gold of a diameter of about 2 mm. Arranged substantially concentrically around the working electrode 3 of gold is a counterpart electrode 4 which, in the illustrated embodiment, is a cylinder or ring of silver galvanically covered with AgCl. Provided between the working electrode 3 of gold and the counterpart electrode 4 is a casing 5 of an electrically insulating material. Contacting of the electrodes 3 and 4 is effected by way of contact wires 6 and 7 respectively which are passed from the electrodes 3 and 4 through the electrode shaft 1 to an electronic measuring system (not shown).

The sensor shown in FIG. 1 further includes a membrane cap 8 which is fitted on over the electrode body 2 and secured preferably by screwing to the electrode shaft 1 or the electrode body 2 respectively. The membrane cap 8 separates the internal electrolyte with the working and counterpart electrodes from the measurement solution in which the sensor is immersed. At the end which is the lower end in FIG. 1 the membrane cap 8 is provided with a membrane 9, preferably a hydrophilised polyvinylidene fluoride membrane with a pore size of 0.5 μm. In a preferred embodiment the membrane is clamped (not shown) by means of a clamping ring in a groove on the membrane cap 8. The internal space of the membrane cap is filled with an internal electrolyte which is in contact both with the membrane 9 and also the electrodes 3 and 4. A 50 mM KCl solution which is thickened with 40 g/L of hydroxyethylcellulose is advantageously suitable as the internal electrolyte.

Further provided on the membrane cap 8 is a pressure equalisation bore 10 which is covered over by a silicone ring 11 which extends around the membrane cap 8 in a groove thereon. The silicone ring 11 prevents measurement solution from passing through the pressure equalisation bore 10 into the membrane cap 8 but it allows excess electrolyte to issue through the pressure equalisation bore 10 when the membrane cap 8 is screwed on.

FIG. 2 shows cyclovoltammograms (current-voltage diagrams) in tap water (TW) without chlorite as a so-called zero solution and with 2.5 ppm of chlorite respectively, in each case at a pH-value of 7.2, using the chlorite sensor according to the invention as shown in FIG. 1. The working potential for amperometric operation of the sensor can be derived from the cyclovoltammograms. The current in the anodic plateau region (illustrated between the vertical lines) between about 1000 and 1100 mV in relation to the normal hydrogen electrode (NHE) is directly proportional to the concentration of chlorite in the solution.

FIG. 3 shows the dependency of the zero point signal and FIG. 4 shows the dependency of the chlorite signal in each case on the pH-value of the measurement solution (tap water) using sensors with three different working electrode materials (gold, platinum and glass carbon), which were measured with the same test arrangement. The solution which was used for the results shown in FIG. 3 contained no chlorite. The solution which was used for the results shown in FIG. 4 contained 0.5 ppm of chlorite. The working electrode potential in each case was 1000 mV in relation to NHE. The respective pH-value was set with NaOH and HCl respectively. The working electrode of glass carbon clearly exhibits a strong, non-linear dependency of the measurement signal on the pH-value of the measurement solution. In comparison the measured potentials in the arrangements with working electrodes of platinum and gold are substantially constant over the pH-value range investigated.

FIG. 5 shows characteristic curves of chlorite sensors with working electrodes of gold and platinum respectively, which were measured at a constant pH-value of 8.0, and over a chlorite range of 0 to 2 ppm of chlorite in tap water. The working electrode potential in each case was 1000 mV in relation to NHE. The sensor with the working electrode of gold clearly produced a markedly stronger increase in current over the measurement range of 0 to 2 ppm of chlorite with a steeper measurement curve in relation to the sensor with a working electrode of platinum. That clearly demonstrates the advantages of the working electrode of gold over those of platinum as a steeper measurement curve with greater current differences between various chlorite concentrations permits more accurate and more sensitive chlorite measurements.

In summary the results shown in FIGS. 3 to 5 clearly demonstrate the advantages of the gold working electrode in determining chlorite in the low range of concentration in relation to working electrodes of glass carbon on the one hand and other precious metal electrodes on the other hand. In comparison with working electrodes of glass carbon the precious metal electrodes are distinguished by the measurement signal being independent of the pH-value of the measurement solution, at least in the pH-value range of about 6.0 to 9.5. In addition the working electrode of gold has the advantage over that of other precious metal such as platinum, that it permits very high working potentials, whereby cross-sensitivity in relation to accompanying substances is eliminated and it produces a considerably steeper current pattern over the chlorite concentration so that the chlorite sensor is overall more accurate and more sensitive at low levels of chlorite concentration. The chlorite sensor according to the invention is therefore excellently well suited for determining low quantities of toxic chlorite in tap water and is better than known devices.

1. A sensor for electrical measurement of the chlorite concentration (CIO₂⁻) in an aqueous measurement solution wherein the sensor has a working electrode of gold.

2. The sensor of claim 1 wherein the electrical measurement in a voltametric or amperometric measurement.

3. A sensor according to claim 2 wherein the working electrode is in the form of an open electrode for direct contact with the measurement solution.

4. A sensor according to claim 2 wherein the working electrode is spatially separated from the measurement solution by a membrane.

5. A sensor according to claim 4 wherein the membrane is a hydrophilic membrane.

6. A sensor according to claim 5 wherein the membrane is a hydrophilized membrane.

7. A sensor according to claim 4 wherein the membrane comprises polyvinylidene difluoride or polyethyleneterephthalate.

8. A sensor according to claim 4 wherein the membrane has a pore size of 0.1 to 5 μm.

9. A sensor according to claim 5 wherein the membrane has a pore size of 0.1 to 5 μm.

10. A sensor according to claim 8 wherein the membrane has a pore size of 0.2 to 1.0 μm.

11. A sensor according to claim 1 wherein the working electrode on the sensor is surrounded by a membrane cap which separates the working electrode from the measurement solution, wherein the membrane cap is filled with an internal electrolyte which is in contact with the working electrode and the membrane cap has at least one membrane which separates the internal space of the membrane cap and the external space of the measurement solution.

12. A sensor according to claim 4 wherein the working electrode on the sensor is surrounded by a membrane cap which separates the working electrode from the measurement solution, wherein the membrane cap is filled with an internal electrolyte which is in contact with the working electrode and the membrane cap has at least one membrane which separates the internal space of the membrane cap and the external space of the measurement solution.

13. A sensor according to claim 1 wherein it has at least one further electrode as a counterpart electrode.

14. A sensor according to claim 4 wherein it has at least one further electrode as a counterpart electrode.

15. The sensor of claim 13 wherein the counterpart electrode is a silver electrode covered with silver chloride.

16. The sensor of claim 13 wherein the counterpart electrode is a silver electrode covered with silver chloride.

17. A sensor according to claim 13 wherein it has a silver electrode covered with silver chloride as a reference electrode through which current does not flow, for applying a working potential, in addition to the counterpart electrode through which current flows.

18. A sensor according to claim 14 wherein it has a silver electrode covered with silver chloride as a reference electrode through which current does not flow, for applying a working potential, in addition to the counterpart electrode through which current flows.

19. A method of measuring the chlorite concentration in an aqueous measurement solution in which the sensor according to claim 1 is used and a constant anodic potential of +900 to +1150 mV in relation to a normal hydrogen electrode is applied between the working electrode and a counterpart electrode as a working voltage and the current flowing at the working voltage is measured.

20. A method of measuring the chlorite concentration in an aqueous measurement solution in which the sensor according to claim 2 is used and a constant anodic potential of +900 to +1150 mV in relation to a normal hydrogen electrode is applied between the working electrode and a counterpart electrode as a working voltage and the current flowing at the working voltage is measured.

21. A method of measuring the chlorite concentration in an aqueous measurement solution in which the sensor according to claim 4 is used and a constant anodic potential of +900 to +1150 mV in relation to a normal hydrogen electrode is applied between the working electrode and a counterpart electrode as a working voltage and the current flowing at the working voltage is measured.

22. A method of measuring the chlorite concentration in an aqueous measurement solution in which the sensor according to claim 11 is used and a constant anodic potential of +900 to +1150 mV in relation to a normal hydrogen electrode is applied between the working electrode and a counterpart electrode as a working voltage and the current flowing at the working voltage is measured.

23. A method according to claim 19 wherein a working voltage is +1000 to +1100 mV in relation to a normal hydrogen electrode.

24. A method according to claim 20 wherein a working voltage is +1000 to +1100 mV in relation to a normal hydrogen electrode.

25. A method according to claim 21 wherein a working voltage is +1000 to +1100 mV in relation to a normal hydrogen electrode.

26. Use of gold as a working electrode in a sensor for amperometric measurement of chlorite concentration (CIO₂) in an aqueous solution.
